(19) United States
(12) Patent Application Publication
(10) Pub. No.: US 2007/0025357 A1
(43) Pub. Date: Feb. 1, 2007

(54) Wireless communication method and apparatus for detecting and scheduling urgent data

(75) Inventors: Guodong Zhang, Farmingdale, NY (US); Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/231,911

(22) Filed: Sep. 21, 2005

Related U.S. Application Data
(60) Provisional application No. 60/702,859, filed on Jul. 27, 2005.

(51) Int. Cl. H04L 12/28

(52) U.S. Cl. 370/395.4

(57) ABSTRACT

Urgent data is scheduled in a wireless communication system including at least one wireless transmit/receive unit (WTRU) and at least one Node-B. The WTRU includes a re-ordering release timer. The Node-B includes a buffer, a lifespan (or maximum allowed delay) timer and a high speed downlink packet access (HSDPA) scheduler. The HSDPA scheduler determines whether there is at least one protocol data unit (PDU) in the buffer whose lifespan (maximum allowed delay) timer or re-ordering release timer will expire if the PDU is not transmitted in a next N transmission timing interval (TTI), where N is a design parameter. If so, the PDU is treated as urgent data whereby a sequence of WTRUs, (i.e., users), scheduled to receive urgent data is arranged in an order of decreasing priority, and a more conservative modulation and coding scheme (MCS), multiple code transmission and a different redundancy reversion are considered for use.

### CROSS REFERENCE TO RELATED APPLICATION

This application claims the benefit of U.S. provisional application No. 60/702,859 filed Jul. 27, 2005, which is incorporated by reference as if fully set forth.

### FIELD OF INVENTION

The present invention is related to a wireless communication system including at least one Node-B and at least one wireless transmit/receive unit (WTRU). More particularly, the present invention is related to data scheduling strategies and algorithms by which the wireless communication system can minimize the radio link control (RLC) recovery of data for high speed downlink packet access (HSDPA).

### BACKGROUND

The basic principle of HSDPA is that the Node-B can make more efficient decisions and manage downlink radio resources on a short-term basis better than the radio network controller (RNC). In the meantime, the RNC still retains coarse overall control of a cell so that it can perform functions such as call admission control (CAC) and congestion control.

Because of the medium access control (MAC) layer hybrid automatic repeat request (HARQ), each individual downlink HSDPA transmission may require a different number of retransmissions to be successfully received by the WTRU. Then, there could be several independent uplink transmissions processed between a universal terrestrial radio access network (UTRAN) and the WTRU within a common time interval.

To limit the impact on system architecture, it is expected that protocol layers above the MAC layer should not be affected by introduction of the HSDPA. One requirement that is introduced by this is the in-sequence data delivery to the RLC protocol layer. The re-ordering function at the WTRU is responsible for organizing the received data blocks according to the sequence generated by the UTRAN RLC entity.

There are two cases where the out-of-sequence delivery to the RLC will occur:

1.) The re-ordering release timer controls the stall avoidance in the WTRU re-ordering buffer. A timer will be started when a high speed MAC (MAC-hs) protocol data unit (PDU) is correctly received but cannot be delivered to the disassembly function. If the re-ordering release timer expires, the re-ordering buffer at the WTRU will be flushed. Out-of-sequence delivery to the RLC (the WTRU side) occurs. The RLC at the WTRU will send an RLC status report to the RLC at the SRNC, which will recover the missed PDUs.

2.) Based on a delay attribute provided by upper layers, the scheduler may decide to discard any “out-of-date” PDUs. Later on, discarded PDUs will be recovered by the RLC.

In both cases, the RLC at the receiver, (i.e., in the WTRU), will send a status report to the RLC at the transmitter, (i.e., the Node-B). Then, the RLC at the transmitter will recover the missing data. However, the RLC recovery of data will cause a significant delay. To avoid the significant delay, RLC recovery of data should be minimized.

### SUMMARY

The present invention is related to scheduling urgent data in a wireless communication system including at least one WTRU and at least one Node-B. The Node-B includes a buffer, a lifespan (or maximum allowed delay) timer and an HSDPA scheduler. The HSDPA scheduler determines whether there is at least one PDU in the buffer whose lifespan (maximum allowed delay) timer or re-ordering release timer will expire if the PDU is not transmitted in a next N transmission timing interval (TTI), where N is a design parameter. If so, the PDU is treated as urgent data whereby a sequence of WTRUs, (i.e., users), scheduled to receive urgent data is arranged in an order of decreasing priority, and a more conservative modulation and coding scheme (MCS), multiple code transmission and a redundancy reversion other than one used in a previous transmission are considered for use.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is a block diagram of a wireless communication system operating in accordance with the present invention; and

FIGS. 2A and 2B, taken together, are a flow diagram of a data scheduling process implemented by the wireless communication system of FIG. 1.

### DETAILED DESCRIPTION OF THE PREFERRED EMBODIMENTS

Hereafter, the terminology “WTRU” includes but is not limited to a user equipment (UE), a mobile station, a laptop, a personal data assistant (PDA), a fixed or mobile subscriber unit, a pager, or any other type of device capable of operating in a wireless environment. When referred to hereafter, the terminology “Node-B” includes but is not limited to a base station, a site controller, an access point (AP) or any other type of interfacing device in a wireless environment.

The features of the present invention may be incorporated into an integrated circuit (IC) or be configured in a circuit comprising a multitude of interconnecting components.

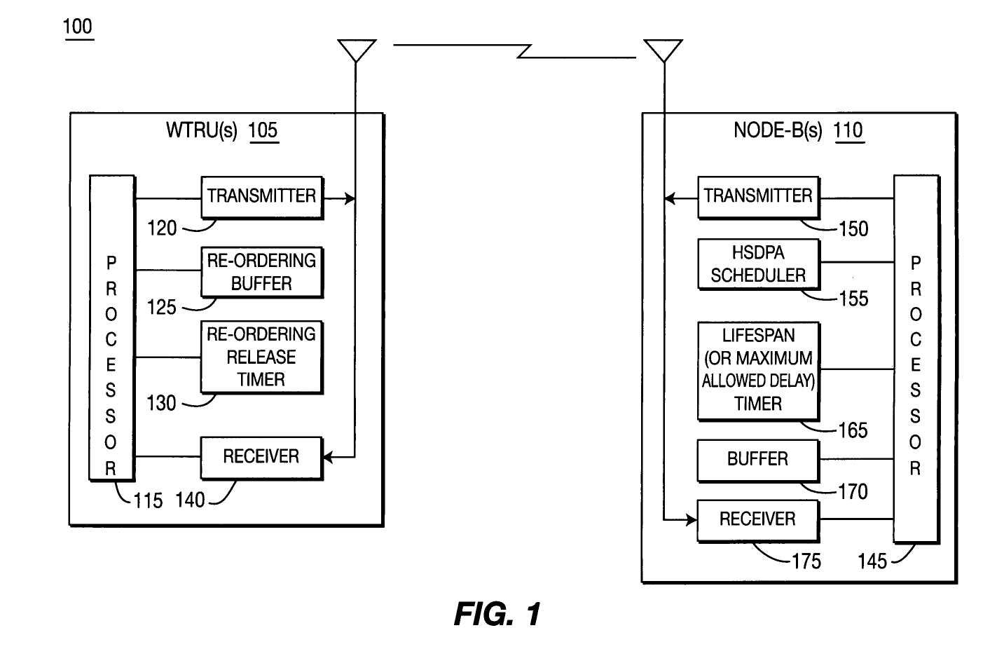

FIG. 1 is a block diagram of a wireless communication system 100 operating in accordance with the present invention. The wireless communication system 100 includes at least one WTRU 105 in communication with at least one Node-B 110. The WTRU 105 includes a processor 115, a transmitter 120, a re-ordering buffer 125, a re-ordering release timer 130 and a receiver 140. The Node-B 110 includes a processor 145, a transmitter 150, an HSDPA scheduler 155, a lifespan timer 165, a buffer 170 and a receiver 175.

The present invention appropriately schedules urgent data that may cause RLC recovery of data for HSDPA services in universal mobile telecommunications system frequency division duplex (UMTS-FDD) and UMTS-time division duplex (TDD) systems. By scheduling of urgent data in an efficient manner, the RLC recovery of data is minimized and significant delay of PDUs is avoided.

The HSDPA scheduler 155 of the Node-B 110 prioritizes the scheduling of urgent data that may cause RLC recovery of data over normal, (i.e., non-urgent), data. In order to minimize the RLC recovery, a more robust modulation and coding scheme (MCS) is used for the prioritized transmission of urgent data. Multiple codes may be used for transmission of urgent data. If the capability of the WTRU 105 allows redundancy reversion, a redundancy version other than those used in previous transmissions is used for transmission of urgent data.

Urgent data may be associated with a PDU that will reach the end of its lifespan, (or is closely approaching a maximum allowed delay), as determined by a lifespan timer 165, if the PDU is not transmitted in a next N TTI, where N is a design parameter. Urgent data may also be associated with a PDU whose re-ordering release timer 130 will expire if the PDU is not transmitted in the next N TTI.

The normalized channel quality is defined in Equation (1) as follows:

$${Normalized\_CQ}_{i} = \frac{{( C \text{/} I )}_{i}}{( {R}_{ave} ( i ) / {R}_{RAB} ( i ) )} \qquad Equation ( 1 )$$

where (C/I)ᵢ is the channel quality, (i.e., carrier to interference ratio), for a user, (i.e., a WTRU 105), i which is provided to the Node-B 110 via a channel quality indicator (CQI) measurement by the WTRU 105, R_{RAB}(i) is the expected data rate of the radio access bear (RAB) when configured by the RNC, and Rₐᵥₑ(i) is the average throughput of user i over a specific time window up to the scheduling time instant. The time window only counts the time when the user i has data in the Node-B 110. Then,

$$\frac{{R}_{ave} ( i )}{{R}_{RAB} ( i )}$$

may be regarded as the normalized average throughput of the user i. The fairness is implied in the normalized throughput within a specific time window, Rₐᵥₑ(i)/R_{RAB}(i).

In the Node-B 110, the HSDPA scheduler 155, in conjunction with the processor 145, determines whether there is urgent data in the buffer 170 that will cause RLC recovery of data if not transmitted immediately. The HSDPA scheduler 155, in conjunction with the processor 145 and the buffer 170, also monitors the maximum allowed delay of a PDU by recording the time when a PDU arrives at the Node-B 110 from an S-RNC (not shown) via a frame control at a time, Tₐ. The PDU is discarded if the PDU is not transmitted by Tₐ+Dₘₐₓ, where Dₘₐₓ is the maximum allowed delay of the PDU.

The HSDPA scheduler 155 keeps track of which PDUs have been positively acknowledged (ACKed) or negatively acknowledged (NACKed). If a PDU is ACKed, but a PDU(s) with a lower sequence number has not yet been ACKed, the HSDPA scheduler 155, alone or in conjunction with the processor 145, determines that a stall has occurred in the re-ordering buffer 125 in the WTRU 105, and that the re-ordering release timer 130 in the WTRU 105 has been started. A PDU(s) with a lower sequence number that has not yet been ACKed is referred to as a missing PDU(s).

The difference between the time at which a PDU (transmitted by the Node-B 110) is received at the WTRU 105, T_{PDU}_{_{—}}_{received}, and the time that an ACK or NACK is generated by the Node-B 110, T_{(N)ACK}, in response to the WTRU 105 transmitting the PDU to the Node-B 110, is defined as a fixed time difference, T_{fixed}_{_{—}}ₜᵢₘₑ_{_{—}}_{diff}, where T_{fixed}_{_{—}}ₜᵢₘₑ_{_{—}}_{diff}=T_{(N)ACK}−T_{PDU}_{_{—}}_{received}. The HSDPA scheduler 155, alone or in conjunction with the processor 145, knows that the re-ordering release timer 130 in the WTRU 105 is started at a time, Tᵣₒᵣ_{_{—}}ₛₜₐᵣₜ, where Tᵣₒᵣ_{_{—}}ₛₜₐᵣₜ=T_{(N)ACK}−T_{fixed}_{_{—}}ₜᵢₘₑ_{_{—}}_{diff}.

If the re-ordering release timer 130 in the WTRU 105 is set to a value, Tᵣₒᵣ, and a missing PDU is not received by the WTRU 105 before the time T_{(N)ACK}−T_{fixed}_{_{—}}ₜᵢₘₑ_{_{—}}_{diff}+Tᵣₒᵣ, the re-ordering release timer 130 expires and the re-ordering buffer 125 in the WTRU 105 is flushed. This causes out-of-sequence delivery to the RLC.

The HSDPA scheduler 155 in the Node-B 110 prioritizes the transmission of urgent data so that the probability that the urgent data is received correctly at the WTRU 105 before the lifespan (or maximum allowed delay) timer 165 (located at the Node-B 110) expires, or the re-ordering release timer 130 expires. Thus, the HSDPA scheduler 155 should prioritize the transmission of urgent data so that the RLC recovery of data is minimized.

At each TTI, the HSDPA scheduler 155 at the Node-B 110 determines whether there is any urgent data for one or more WTRUs 105 stored in the buffer 170 in the Node-B 110 using one of the schemes described above. If there is urgent data in the buffer 170, the HSDPA scheduler 155 considers transmitting as much urgent data in the buffer 170 as possible in this TTI before considering other data, (which are not urgent). The HSDPA scheduler 155 arranges the urgent data for those WTRUs 105 into a sequence in an order of decreasing priority associated with the urgent data. If two or more WTRUs 105, for which urgent data is arranged, have the same priority, the WTRU 105 associated with a better normalized channel quality, Normalized_CQᵢ, is favored.

Downlink transmission is limited by the maximum allowed transmit power of the Node-B 110. If there is enough transmit power available, a more conservative, (i.e., more robust), MCS should be chosen so that there is a high probability that the urgent data is received correctly. If there are enough physical channels, (i.e., high speed physical downlink shared channel (HS-PDSCH) codes having a spreading factor of 16), multiple codes can be used for transmission. This decreases the effective coding rate of the transmission, thus making the transmission more robust, which increases the probability that the urgent data is received correctly before the critical timer expires.

If the capability of the WTRU 105 is sufficient, a different redundancy reversion other than the one used in previous transmissions should be used for transmission of urgent data. That means different bits will be punctured or repeated compared to previous transmissions, which will increase gain of soft-combining at the receiver of the WTRU 105.

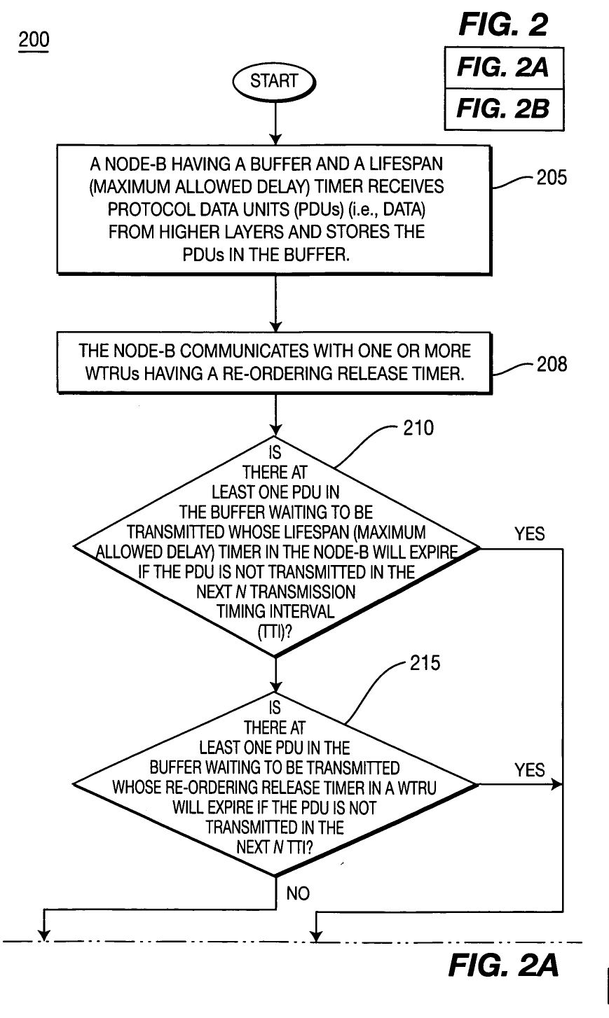

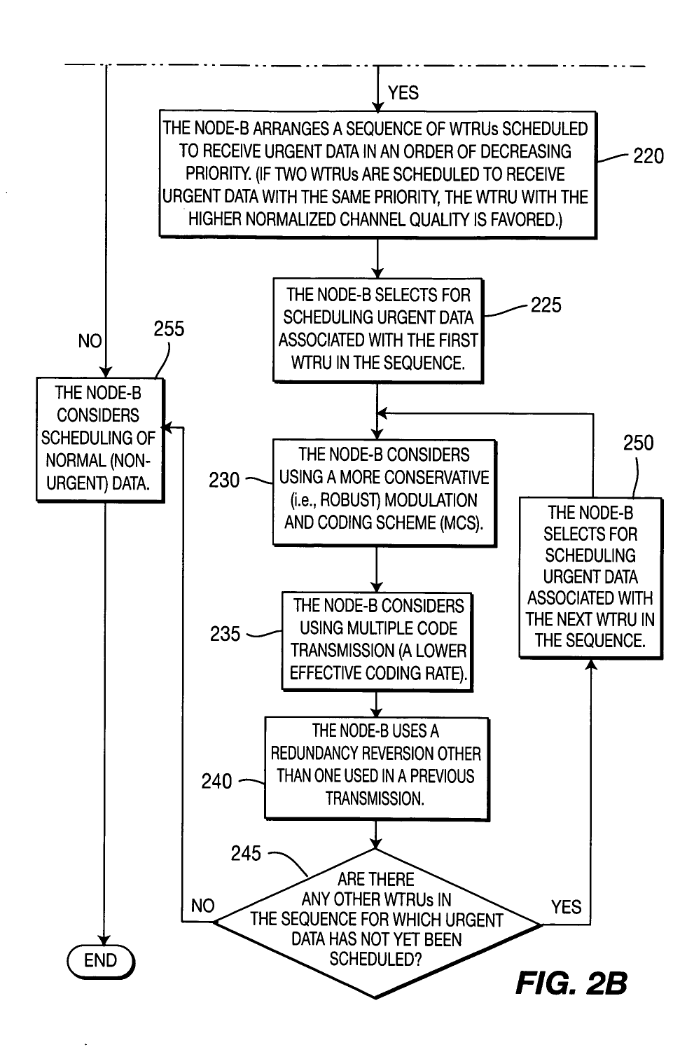

FIGS. 2A and 2B, taken together, are a flow diagram of a process 200 including method steps for scheduling data in the wireless communication system 100 of FIG. 1. In step 205, a Node-B 110 having a buffer 170 and a lifespan (or maximum allowed delay) timer receives PDUs, (i.e., data), from higher layers and stores the PDUs in the buffer 170. In step 208, the Node-B 110 communicates with one or more WTRUs 105 having a re-ordering release timer 130. In steps 210 and 215, a determination is made as to whether or not there is any urgent data in the buffer 170 in the Node-B 110 waiting to be transmitted by the transmitter 150.

Specifically, in step 210, the data in the buffer 170 is determined to be urgent if there is at least one PDU in the buffer 170 waiting to be transmitted whose lifespan (or maximum allowed delay) timer 165 in the Node-B 110 will expire if the PDU is not transmitted in the next N TTI, (i.e., the lifespan timer 165 is close to expiring).

If the data in the buffer 170 is not determined to be urgent in step 210, a different scheme may be used whereby the data in the buffer 170 is determined to be urgent if there is at least one PDU in the buffer 170 waiting to be transmitted whose re-ordering release timer 130 in the WTRU 105 will expire if the PDU is not transmitted in the next N TTI, (i.e., the re-ordering release timer 130 is close to expiring). Steps 210 and 215 may be interchanged, whereby step 215 may be implemented before step 210. Alternatively, only one of steps 210 and 215 may be implemented.

If there is urgent data waiting to be transmitted, as determined in one of steps 210 and 215, the Node-B 110 arranges a sequence of WTRUs 105, (i.e., users), scheduled to receive urgent data in an order of decreasing priority (step 220). If two WTRUs 105 are scheduled to receive urgent data with the same priority, the WTRU 105 with the higher normalized channel quality is favored, (i.e., scheduling data is selected for the favored WTRU 105 first).

In step 225, the Node-B selects for scheduling urgent data associated with the first WTRU in the sequence, whereby the HSDPA scheduler 155 in the Node-B 110 starts to schedule data transmission or retransmission for the first WTRU.

In step 230, the Node-B 110, (i.e., the transmitter 150), considers using a more conservative, (i.e., robust), MCS, (i.e., a lower order of modulation and lower channel coding rate). This is applicable for retransmissions only. If a previous transmission uses high order of modulation (16 QAM), then a low order modulation (QPSK) may be considered. For example, if a previous transmission uses a coding rate of ½, then a coding rate lower than ½ may be considered.

In step 235, the Node-B 110, (i.e., the transmitter 150), considers using multiple code transmission, (i.e., a lower effective channel coding rate). If a previous transmission uses a specific number of downlink codes, then more than the specific number of downlink codes may be considered for retransmission. This will also result in a lower channel coding rate. Similar to step 230, this is applicable for retransmissions only.

In step 240, the Node-B 110, (i.e., the transmitter 150), considers using a redundancy reversion other than one used in a previous transmission(s). Similar to step 230, this is applicable for retransmissions only. For example, if a redundancy reversion 1 is used in a previous transmission, then a redundancy reversion 2 may be used for retransmission.

In step 245, a determination is made as to whether there are any other WTRUs 105 in the sequence that have not yet been scheduled. If so, the Node-B, (i.e., the HSDPA scheduler 155), selects for scheduling urgent data associated with the next WTRU 105 in the sequence (step 250), and then the process 200 repeats steps 230-245. If there are no more WTRUs 105 in the sequence for which urgent data has not yet been scheduled, as determined at step 245, or there is no urgent data waiting to be processed, as determined at steps 210 and/or 215, the Node-B, (i.e., the HSDPA scheduler 155), considers scheduling normal, (i.e., non-urgent), data at step 255.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a wireless communication system including at least one Node-B with a buffer for storing data including at least one protocol data unit (PDU) and at least one wireless transmit/receive unit (WTRU), a method of scheduling urgent data comprising:
(a) determining whether there is at least one PDU in the buffer in the Node-B waiting to be transmitted, wherein the lifespan of the PDU will expire if the PDU is not transmitted by the Node-B in a next N transmission timing interval (TTI), where N is a design parameter; and
(b) treating the PDU as urgent data if it is determined in step (a) that the PDU is close to the end of its lifespan.

2. The method of claim 1 wherein step (b) comprises:
(b1) the Node-B arranging a sequence of WTRUs scheduled to receive urgent data in an order of decreasing priority;
(b2) the Node-B selecting for scheduling urgent data associated with a first WTRU in the sequence;
(b3) the Node-B considering using a more conservative modulation and coding scheme (MCS);
(b4) the Node-B considering using multiple code transmission; and
(b5) the Node-B using a redundancy reversion other than one used in a previous transmission.

3. The method of claim 2 wherein step (b) further comprises:
(b6) the Node-B selecting for scheduling urgent data associated with the next WTRU in the sequence if there are more physical resources available; and
(b7) repeating steps (b3)-(b6) until there are no more WTRUs in the sequence for which urgent data has not been scheduled.

4. The method of claim 3 further comprising:
(c) the Node-B scheduling non-urgent data if there are no WTRUs in the sequence for which urgent data has not been scheduled.

5. In a wireless communication system including at least one Node-B with a buffer for storing data including at least one protocol data unit (PDU) and at least one wireless transmit/receive unit (WTRU), a method of scheduling urgent data comprising:
(a) determining whether there is at least one PDU in the buffer in the Node-B waiting to be transmitted, wherein a maximum allowed delay of the PDU will be reached if the PDU is not transmitted by the Node-B in a next N transmission timing interval (TTI), where N is a design parameter; and
(b) treating the PDU as urgent data if it is determined in step (a) that the delay of the PDU is closely approaching the maximum allowed delay.

6. The method of claim 5 wherein step (b) comprises:
(b1) the Node-B arranging a sequence of WTRUs scheduled to receive urgent data in an order of decreasing priority;
(b2) the Node-B selecting for scheduling urgent data associated with a first WTRU in the sequence;
(b3) the Node-B considering using a more conservative modulation and coding scheme (MCS);
(b4) the Node-B considering using multiple code transmission; and
(b5) the Node-B using a redundancy reversion other than one used in a previous transmission.

7. The method of claim 6 wherein step (b) further comprises:
(b6) the Node-B selecting for scheduling urgent data associated with the next WTRU in the sequence if there are more physical resources available; and
(b7) repeating steps (b3)-(b6) until there are no more WTRUs in the sequence for which urgent data has not been scheduled.

8. The method of claim 7 further comprising:
(c) the Node-B scheduling non-urgent data if there are no WTRUs in the sequence for which urgent data has not been scheduled.

9. In a wireless communication system including at least one Node-B with a buffer for storing data including at least one protocol data unit (PDU), a method of scheduling urgent data comprising:
(a) determining whether there is at least one PDU in the buffer in the Node-B waiting to be transmitted, wherein the lifespan of the PDU will expire if the PDU is not transmitted by the Node-B in a next N transmission timing interval (TTI), where N is a design parameter; and
(b) the Node-B considering using a more robust modulation and coding scheme (MCS) if it is determined in step (a) that the PDU is close to the end of its lifespan.

10. In a wireless communication system including at least one Node-B with a buffer for storing data including at least one protocol data unit (PDU), a method of scheduling urgent data comprising:
(a) determining whether there is at least one PDU in the buffer in the Node-B waiting to be transmitted, wherein the lifespan of the PDU will expire if the PDU is not transmitted by the Node-B in a next N transmission timing interval (TTI), where N is a design parameter; and
(b) the Node-B considering using multiple code transmission if it is determined in step (a) that the PDU is close to the end of its lifespan.

11. In a wireless communication system including at least one Node-B with a buffer for storing data including at least one protocol data unit (PDU), a method of scheduling urgent data comprising:
(a) determining whether there is at least one PDU in the buffer in the Node-B waiting to be transmitted, wherein the lifespan of the PDU will expire if the PDU is not transmitted by the Node-B in a next N transmission timing interval (TTI), where N is a design parameter; and
(b) the Node-B using a redundancy reversion other than one used in a previous transmission if it is determined in step (a) that the PDU is close to the end of its lifespan.

12. In a wireless communication system including at least one Node-B with a buffer for storing data including at least one protocol data unit (PDU) and at least one wireless transmit/receive unit (WTRU), a method of scheduling urgent data comprising:
(a) determining that there is at least one PDU in the buffer in the Node-B waiting to be transmitted, wherein the lifespan of the PDU will expire if the PDU is not transmitted by the Node-B in a next N transmission timing interval (TTI), where N is a design parameter;
(b) arranging a sequence of WTRUs scheduled to receive urgent data in an order of decreasing priority; and
(c) sequentially selecting for scheduling urgent data associated with each of the WTRUs in accordance with the sequence arranged in step (b).

13. In a wireless communication system including at least one Node-B with a buffer for storing data including at least one protocol data unit (PDU), a method of scheduling urgent data comprising:
(a) determining whether there is at least one PDU in the buffer in the Node-B waiting to be transmitted, wherein a maximum allowed delay of the PDU will be reached if the PDU is not transmitted by the Node-B in a next N transmission timing interval (TTI), where N is a design parameter; and
(b) the Node-B considering using a more robust modulation and coding scheme (MCS) if it is determined in step (a) that the delay of the PDU is closely approaching the maximum allowed delay.

14. In a wireless communication system including at least one Node-B with a buffer for storing data including at least one protocol data unit (PDU), a method of scheduling urgent data comprising:
(a) determining whether there is at least one PDU in the buffer in the Node-B waiting to be transmitted, wherein a maximum allowed delay of the PDU will be reached if the PDU is not transmitted by the Node-B in a next N transmission timing interval (TTI), where N is a design parameter; and
(b) the Node-B considering using multiple code transmission if it is determined in step (a) that the delay of the PDU is closely approaching the maximum allowed delay.

15. In a wireless communication system including at least one Node-B with a buffer for storing data including at least one protocol data unit (PDU), a method of scheduling urgent data comprising:
(a) determining whether there is at least one PDU in the buffer in the Node-B waiting to be transmitted, wherein a maximum allowed delay of the PDU will be reached if the PDU is not transmitted by the Node-B in a next N transmission timing interval (TTI), where N is a design parameter; and
(b) the Node-B using a redundancy reversion other than one used in a previous transmission if it is determined in step (a) that the delay of the PDU is closely approaching the maximum allowed delay.

16. In a wireless communication system including at least one Node-B with a buffer for storing data including at least one protocol data unit (PDU) and at least one wireless transmit/receive unit (WTRU), a method of scheduling urgent data comprising:
(a) determining that there is at least one PDU in the buffer in the Node-B waiting to be transmitted, wherein a maximum allowed delay of the PDU will be reached if the PDU is not transmitted by the Node-B in a next N transmission timing interval (TTI), where N is a design parameter;
(b) arranging a sequence of WTRUs scheduled to receive urgent data in an order of decreasing priority; and
(c) sequentially selecting for scheduling urgent data associated with each of the WTRUs in accordance with the sequence arranged in step (b).

17. In a wireless communication system including at least one wireless transmit/receive unit (WTRU), a Node-B for scheduling urgent data comprising:
(a) a buffer for storing data including at least one protocol data unit (PDU);
(b) a lifespan timer which defines the lifespan of the PDU;
(c) a transmitter; and
(d) a high speed downlink packet access (HSDPA) scheduler for determining whether there is at least one PDU in the buffer in the Node-B waiting to be transmitted by the transmitter, wherein the lifespan timer will expire if the PDU is not transmitted by the transmitter in a next N transmission timing interval (TTI), where N is a design parameter, and the HSDPA scheduler treats the PDU as urgent data if the lifespan timer is close to expiring.

18. The Node-B of claim 17 wherein the HSDPA scheduler arranges a sequence of WTRUs scheduled to receive urgent data in an order of decreasing priority, and sequentially selects for scheduling urgent data associated with each of the WTRUs in accordance with the sequence.

19. The Node-B of claim 17 wherein the Node-B considers using a more conservative modulation and coding scheme (MCS) if the lifespan timer is close to expiring.

20. The Node-B of claim 17 wherein the Node-B considers using multiple code transmission if the lifespan timer is close to expiring.

21. The Node-B of claim 17 wherein the Node-B uses a redundancy reversion other than one used in a previous transmission if the lifespan timer is close to expiring.

22. The Node-B of claim 17 wherein the HSDPA scheduler schedules non-urgent data if there are no WTRUs in the sequence for which urgent data has not been scheduled.

23. In a wireless communication system including at least one wireless transmit/receive unit (WTRU), a Node-B for scheduling urgent data comprising:
(a) a buffer for storing data including at least one protocol data unit (PDU);
(b) a lifespan timer which defines a maximum allowed delay of the PDU;
(c) a transmitter; and
(d) a high speed downlink packet access (HSDPA) scheduler for determining whether there is at least one PDU in the buffer in the Node-B waiting to be transmitted by the transmitter, wherein the lifespan timer will expire if the PDU is not transmitted by the transmitter in a next N transmission timing interval (TTI), where N is a design parameter, and the HSDPA scheduler treats the PDU as urgent data if the lifespan timer is closely approaching the maximum allowed delay.

24. The Node-B of claim 23 wherein the HSDPA scheduler arranges a sequence of WTRUs scheduled to receive urgent data in an order of decreasing priority, and sequentially selects for scheduling urgent data associated with each of the WTRUs in accordance with the sequence.

25. The Node-B of claim 23 wherein the Node-B considers using a more conservative modulation and coding scheme (MCS) if the lifespan timer is closely approaching the maximum allowed delay.

26. The Node-B of claim 23 wherein the Node-B considers using multiple code transmission if the lifespan timer is closely approaching the maximum allowed delay.

27. The Node-B of claim 23 wherein the Node-B uses a redundancy reversion other than one used in a previous transmission if the lifespan timer is closely approaching the maximum allowed delay.

28. The Node-B of claim 23 wherein the HSDPA scheduler schedules non-urgent data if there are no WTRUs in the sequence for which urgent data has not been scheduled.

29. An integrated circuit (IC) for scheduling urgent data comprising:
(a) a buffer for storing data including at least one protocol data unit (PDU);
(b) a lifespan timer which defines the lifespan of the PDU;
(c) a transmitter; and
(d) a high speed downlink packet access (HSDPA) scheduler for determining whether there is at least one PDU in the buffer waiting to be transmitted by the transmitter, wherein the lifespan timer will expire if the PDU is not transmitted by the transmitter in a next N transmission timing interval (TTI), where N is a design parameter, and the HSDPA scheduler treats the PDU as urgent data if the lifespan timer is close to expiring.

30. The IC of claim 29 wherein the HSDPA scheduler arranges a sequence of users scheduled to receive urgent data in an order of decreasing priority, and sequentially selects for scheduling urgent data associated with each of the users in accordance with the sequence.

31. The IC of claim 29 wherein the transmitter uses a more conservative modulation and coding scheme (MCS) if the lifespan timer is close to expiring.

32. The IC of claim 29 wherein the transmitter uses multiple code transmission if the lifespan timer is close to expiring.

33. The IC of claim 29 wherein the transmitter uses a redundancy reversion other than one used in a previous transmission if the lifespan timer is close to expiring.

34. The IC of claim 29 wherein the HSDPA scheduler schedules non-urgent data if there are no users in the sequence for which urgent data has not been scheduled.

35. An integrated circuit (IC) for scheduling urgent data comprising:
(a) a buffer for storing data including at least one protocol data unit (PDU);
(b) a lifespan timer which defines a maximum allowed delay of the PDU;
(c) a transmitter; and
(d) a high speed downlink packet access (HSDPA) scheduler for determining whether there is at least one PDU in the buffer waiting to be transmitted by the transmitter, wherein the lifespan timer will expire if the PDU is not transmitted by the transmitter in a next N transmission timing interval (TTI), where N is a design parameter, and the HSDPA scheduler treats the PDU as urgent data if the lifespan timer is closely approaching the maximum allowed delay.

36. The IC of claim 35 wherein the HSDPA scheduler arranges a sequence of users scheduled to receive urgent data in an order of decreasing priority, and sequentially selects for scheduling urgent data associated with each of the users in accordance with the sequence.

37. The IC of claim 35 wherein the transmitter uses a more conservative modulation and coding scheme (MCS) if the lifespan timer is closely approaching the maximum allowed delay.

38. The IC of claim 35 wherein the transmitter uses multiple code transmission if the lifespan timer is closely approaching the maximum allowed delay.

39. The IC of claim 35 wherein the transmitter uses a redundancy reversion other than one used in a previous transmission if the lifespan timer is closely approaching the maximum allowed delay.

40. The IC of claim 35 wherein the HSDPA scheduler schedules non-urgent data if there are no WTRUs in the sequence for which urgent data has not been scheduled.

41. In a wireless communication system including at least one wireless transmit/receive unit (WTRU), a Node-B for scheduling urgent data comprising:
(a) a buffer for storing data including at least one protocol data unit (PDU);
(b) a lifespan timer which defines the lifespan of the PDU;
(c) a transmitter; and
(d) a high speed downlink packet access (HSDPA) scheduler for determining whether there is at least one PDU in the buffer in the Node-B waiting to be transmitted by the transmitter, wherein the lifespan timer will expire if the PDU is not transmitted by the transmitter in a next N transmission timing interval (TTI), where N is a design parameter, and the transmitter uses a more conservative modulation and coding scheme (MCS) if the lifespan timer is close to expiring.

42. The Node-B of claim 41 wherein the HSDPA scheduler arranges a sequence of WTRUs scheduled to receive urgent data in an order of decreasing priority, and sequentially selects for scheduling urgent data associated with each of the WTRUs in accordance with the sequence.

43. The Node-B of claim 41 wherein the HSDPA scheduler schedules non-urgent data if there are no WTRUs in the sequence for which urgent data has not been scheduled.

44. In a wireless communication system including at least one wireless transmit/receive unit (WTRU), a Node-B for scheduling urgent data comprising:
(a) a buffer for storing data including at least one protocol data unit (PDU);
(b) a lifespan timer which defines the lifespan of the PDU;
(c) a transmitter; and
(d) a high speed downlink packet access (HSDPA) scheduler for determining whether there is at least one PDU in the buffer in the Node-B waiting to be transmitted by the transmitter, wherein the lifespan timer will expire if the PDU is not transmitted by the transmitter in a next N transmission timing interval (TTI), where N is a design parameter, and the transmitter uses a multiple code transmission if the lifespan timer is close to expiring.

45. The Node-B of claim 44 wherein the HSDPA scheduler arranges a sequence of WTRUs scheduled to receive urgent data in an order of decreasing priority, and sequentially selects for scheduling urgent data associated with each of the WTRUs in accordance with the sequence.

46. The Node-B of claim 44 wherein the HSDPA scheduler schedules non-urgent data if there are no WTRUs in the sequence for which urgent data has not been scheduled.

47. In a wireless communication system including at least one wireless transmit/receive unit (WTRU), a Node-B for scheduling urgent data comprising:
(a) a buffer for storing data including at least one protocol data unit (PDU);
(b) a lifespan timer which defines the lifespan of the PDU;
(c) a transmitter; and
(d) a high speed downlink packet access (HSDPA) scheduler for determining whether there is at least one PDU in the buffer in the Node-B waiting to be transmitted by the transmitter, wherein the lifespan timer will expire if the PDU is not transmitted by the transmitter in a next N transmission timing interval (TTI), where N is a design parameter, and the transmitter uses a redundancy reversion other than one used in a previous transmission if the lifespan timer is close to expiring.

48. The Node-B of claim 47 wherein the HSDPA scheduler arranges a sequence of WTRUs scheduled to receive urgent data in an order of decreasing priority, and sequentially selects for scheduling urgent data associated with each of the WTRUs in accordance with the sequence.

49. The Node-B of claim 47 wherein the HSDPA scheduler schedules non-urgent data if there are no WTRUs in the sequence for which urgent data has not been scheduled.

50. In a wireless communication system including at least one wireless transmit/receive unit (WTRU), a Node-B for scheduling urgent data comprising:
(a) a buffer for storing data including at least one protocol data unit (PDU);
(b) a lifespan timer which defines a maximum allowed delay of the PDU;
(c) a transmitter; and
(d) a high speed downlink packet access (HSDPA) scheduler for determining whether there is at least one PDU in the buffer in the Node-B waiting to be transmitted by the transmitter, wherein the lifespan timer will expire if the PDU is not transmitted by the transmitter in a next N transmission timing interval (TTI), where N is a design parameter, and the transmitter uses a more conservative modulation and coding scheme (MCS) if the delay of the PDU is closely approaching the maximum allowed delay.

51. The Node-B of claim 50 wherein the HSDPA scheduler arranges a sequence of WTRUs scheduled to receive urgent data in an order of decreasing priority, and sequentially selects for scheduling urgent data associated with each of the WTRUs in accordance with the sequence.

52. The Node-B of claim 50 wherein the HSDPA scheduler schedules non-urgent data if there are no WTRUs in the sequence for which urgent data has not been scheduled.

53. In a wireless communication system including at least one wireless transmit/receive unit (WTRU), a Node-B for scheduling urgent data comprising:
(a) a buffer for storing data including at least one protocol data unit (PDU);
(b) a lifespan timer which defines a maximum allowed delay of the PDU;
(c) a transmitter; and
(d) a high speed downlink packet access (HSDPA) scheduler for determining whether there is at least one PDU in the buffer in the Node-B waiting to be transmitted by the transmitter, wherein the lifespan timer will expire if the PDU is not transmitted by the transmitter in a next N transmission timing interval (TTI), where N is a design parameter, and the transmitter uses a multiple code transmission if the delay of the PDU is closely approaching the maximum allowed delay.

54. The Node-B of claim 53 wherein the HSDPA scheduler arranges a sequence of WTRUs scheduled to receive urgent data in an order of decreasing priority, and sequentially selects for scheduling urgent data associated with each of the WTRUs in accordance with the sequence.

55. The Node-B of claim 53 wherein the HSDPA scheduler schedules non-urgent data if there are no WTRUs in the sequence for which urgent data has not been scheduled.

56. In a wireless communication system including at least one wireless transmit/receive unit (WTRU), a Node-B for scheduling urgent data comprising:
(a) a buffer for storing data including at least one protocol data unit (PDU);
(b) a lifespan timer which defines a maximum allowed delay of the PDU;
(c) a transmitter; and
(d) a high speed downlink packet access (HSDPA) scheduler for determining whether there is at least one PDU in the buffer in the Node-B waiting to be transmitted by the transmitter, wherein the lifespan timer will expire if the PDU is not transmitted by the transmitter in a next N transmission timing interval (TTI), where N is a design parameter, and the transmitter uses a redundancy reversion other than one used in a previous transmission if the delay of the PDU is closely approaching the maximum allowed delay.

57. The Node-B of claim 56 wherein the HSDPA scheduler arranges a sequence of WTRUs scheduled to receive urgent data in an order of decreasing priority, and sequentially selects for scheduling urgent data associated with each of the WTRUs in accordance with the sequence.

58. The Node-B of claim 56 wherein the HSDPA scheduler schedules non-urgent data if there are no WTRUs in the sequence for which urgent data has not been scheduled.

59. An integrated circuit (IC) for scheduling urgent data comprising:
(a) a buffer for storing data including at least one protocol data unit (PDU);
(b) a lifespan timer which defines the lifespan of the PDU;
(c) a transmitter; and
(d) a high speed downlink packet access (HSDPA) scheduler for determining whether there is at least one PDU in the buffer waiting to be transmitted by the transmitter, wherein the lifespan timer will expire if the PDU is not transmitted by the transmitter in a next N transmission timing interval (TTI), where N is a design parameter, and the transmitter uses a more conservative modulation and coding scheme (MCS) if the lifespan timer is close to expiring.

60. The IC of claim 59 wherein the HSDPA scheduler arranges a sequence of users scheduled to receive urgent data in an order of decreasing priority, and sequentially selects for scheduling urgent data associated with each of the users in accordance with the sequence.

61. The IC of claim 59 wherein the HSDPA scheduler schedules non-urgent data if there are no users in the sequence for which urgent data has not been scheduled.

62. An integrated circuit (IC) for scheduling urgent data comprising:
(a) a buffer for storing data including at least one protocol data unit (PDU);
(b) a lifespan timer which defines the lifespan of the PDU;
(c) a transmitter; and
(d) a high speed downlink packet access (HSDPA) scheduler for determining whether there is at least one PDU in the buffer waiting to be transmitted by the transmitter, wherein the lifespan timer will expire if the PDU is not transmitted by the transmitter in a next N transmission timing interval (TTI), where N is a design parameter, and the transmitter uses a multiple code transmission if the lifespan timer is close to expiring.

63. The IC of claim 62 wherein the HSDPA scheduler arranges a sequence of users scheduled to receive urgent data in an order of decreasing priority, and sequentially selects for scheduling urgent data associated with each of the users in accordance with the sequence.

64. The IC of claim 62 wherein the HSDPA scheduler schedules non-urgent data if there are no users in the sequence for which urgent data has not been scheduled.

65. An integrated circuit (IC) for scheduling urgent data comprising:
(a) a buffer for storing data including at least one protocol data unit (PDU);
(b) a lifespan timer which defines the lifespan of the PDU;
(c) a transmitter; and
(d) a high speed downlink packet access (HSDPA) scheduler for determining whether there is at least one PDU in the buffer waiting to be transmitted by the transmitter, wherein the lifespan timer will expire if the PDU is not transmitted by the transmitter in a next N transmission timing interval (TTI), where N is a design parameter, and the transmitter uses a redundancy reversion other than one used in a previous transmission if the lifespan timer is close to expiring.

66. The IC of claim 65 wherein the HSDPA scheduler arranges a sequence of users scheduled to receive urgent data in an order of decreasing priority, and sequentially selects for scheduling urgent data associated with each of the users in accordance with the sequence.

67. The IC of claim 65 wherein the HSDPA scheduler schedules non-urgent data if there are no users in the sequence for which urgent data has not been scheduled.

68. An integrated circuit (IC) for scheduling urgent data comprising:
(a) a buffer for storing data including at least one protocol data unit (PDU);
(b) a lifespan timer which defines a maximum allowed delay of the PDU;
(c) a transmitter; and
(d) a high speed downlink packet access (HSDPA) scheduler for determining whether there is at least one PDU in the buffer waiting to be transmitted by the transmitter, wherein the lifespan timer will expire if the PDU is not transmitted by the transmitter in a next N transmission timing interval (TTI), where N is a design parameter, and the transmitter uses a more conservative modulation and coding scheme (MCS) if the delay of the PDU is closely approaching the maximum allowed delay.

69. The IC of claim 68 wherein the HSDPA scheduler arranges a sequence of users scheduled to receive urgent data in an order of decreasing priority, and sequentially selects for scheduling urgent data associated with each of the users in accordance with the sequence.

70. The IC of claim 68 wherein the HSDPA scheduler schedules non-urgent data if there are no users in the sequence for which urgent data has not been scheduled.

71. An integrated circuit (IC) for scheduling urgent data comprising:
(a) a buffer for storing data including at least one protocol data unit (PDU);
(b) a lifespan timer which defines a maximum allowed delay of the PDU;
(c) a transmitter; and
(d) a high speed downlink packet access (HSDPA) scheduler for determining whether there is at least one PDU in the buffer waiting to be transmitted by the transmitter, wherein the lifespan timer will expire if the PDU is not transmitted by the transmitter in a next N transmission timing interval (TTI), where N is a design parameter, and the transmitter uses a multiple code transmission if the delay of the PDU is closely approaching the maximum allowed delay.

72. The IC of claim 71 wherein the HSDPA scheduler arranges a sequence of users scheduled to receive urgent data in an order of decreasing priority, and sequentially selects for scheduling urgent data associated with each of the users in accordance with the sequence.

73. The IC of claim 71 wherein the HSDPA scheduler schedules non-urgent data if there are no users in the sequence for which urgent data has not been scheduled.

74. An integrated circuit (IC) for scheduling urgent data comprising:
(a) a buffer for storing data including at least one protocol data unit (PDU);
(b) a lifespan timer which defines a maximum allowed delay of the PDU;
(c) a transmitter; and
(d) a high speed downlink packet access (HSDPA) scheduler for determining whether there is at least one PDU in the buffer waiting to be transmitted by the transmitter, wherein the lifespan timer will expire if the PDU is not transmitted by the transmitter in a next N transmission timing interval (TTI), where N is a design parameter, and the transmitter uses a redundancy reversion other than one used in a previous transmission if the delay of the PDU is closely approaching the maximum allowed delay.

75. The IC of claim 74 wherein the HSDPA scheduler arranges a sequence of users scheduled to receive urgent data in an order of decreasing priority, and sequentially selects for scheduling urgent data associated with each of the users in accordance with the sequence.

76. The IC of claim 74 wherein the HSDPA scheduler schedules non-urgent data if there are no users in the sequence for which urgent data has not been scheduled.

77. In a wireless communication system including at least one wireless transmit/receive unit (WTRU) with a re-ordering release timer, and at least one Node-B with a buffer for storing data including at least one protocol data unit (PDU), a method of scheduling urgent data comprising:
(a) determining whether there is at least one PDU in the buffer in the Node-B waiting to be transmitted, wherein the re-ordering release timer in the WTRU will expire if the PDU is not transmitted by the Node-B in a next N transmission timing interval (TTI), where N is a design parameter; and
(b) treating the PDU as urgent data if it is determined in step (a) that the re-ordering release timer is close to expiring.

78. The method of claim 77 wherein step (b) comprises:
(b1) the Node-B arranging a sequence of wireless transmit/receive units (WTRUs) scheduled to receive urgent data in an order of decreasing priority;
(b2) the Node-B selecting for scheduling urgent data associated with a first WTRU in the sequence;
(b3) the Node-B considering using a more conservative modulation and coding scheme (MCS);
(b4) the Node-B considering using multiple code transmission; and
(b5) the Node-B using a redundancy reversion other than one used in a previous transmission.

79. The method of claim 78 wherein step (b) further comprises:
(b6) the Node-B selecting for scheduling urgent data associated with the next WTRU in the sequence if there are more physical resources available; and
(b7) repeating steps (b3)-(b6) until there are no more WTRUs in the sequence for which urgent data has not been scheduled.

80. The method of claim 79 further comprising:
(c) the Node-B scheduling non-urgent data if there are no WTRUs in the sequence for which urgent data has not been scheduled.

81. In a wireless communication system including at least one wireless transmit/receive unit (WTRU) with a re-ordering release timer, and at least one Node-B with a buffer for storing data including at least one protocol data unit (PDU), a method of scheduling urgent data comprising:
(a) determining whether there is at least one PDU in the buffer in the Node-B waiting to be transmitted, wherein the re-ordering release timer in the WTRU will expire if the PDU is not transmitted by the Node-B in a next N transmission timing interval (TTI), where N is a design parameter; and
(b) the Node-B considering using a more robust modulation and coding scheme (MCS) if it is determined in step (a) that that the re-ordering release timer is close to expiring.

82. In a wireless communication system including at least one wireless transmit/receive unit (WTRU) with a re-ordering release timer, and at least one Node-B with a buffer for storing data including at least one protocol data unit (PDU), a method of scheduling urgent data comprising:
(a) determining whether there is at least one PDU in the buffer in the Node-B waiting to be transmitted, wherein the re-ordering release timer in the WTRU will expire if the PDU is not transmitted by the Node-B in a next N transmission timing interval (TTI), where N is a design parameter; and
(b) the Node-B considering using multiple code transmission data if it is determined in step (a) that that the re-ordering release timer is close to expiring.

83. In a wireless communication system including at least one wireless transmit/receive unit (WTRU) with a re-ordering release timer, and at least one Node-B with a buffer for storing data including at least one protocol data unit (PDU), a method of scheduling urgent data comprising:
(a) determining whether there is at least one PDU in the buffer in the Node-B waiting to be transmitted, wherein the re-ordering release timer in the WTRU will expire if the PDU is not transmitted by the Node-B in a next N transmission timing interval (TTI), where N is a design parameter; and
(b) the Node-B using a redundancy reversion other than one used in a previous transmission if it is determined in step (a) that that the re-ordering release timer is close to expiring.

84. In a wireless communication system including at least one wireless transmit/receive unit (WTRU) with a re-ordering release timer, and at least one Node-B with a buffer for storing data including at least one protocol data unit (PDU), a method of scheduling urgent data comprising:
(a) determining whether there is at least one PDU in the buffer in the Node-B waiting to be transmitted, wherein the re-ordering release timer in the WTRU will expire if the PDU is not transmitted by the Node-B in a next N transmission timing interval (TTI), where N is a design parameter; and
(b) arranging a sequence of WTRUs scheduled to receive urgent data in an order of decreasing priority; and
(c) sequentially selecting for scheduling urgent data associated with each of the WTRUs in accordance with the sequence arranged in step (b).

85. In a wireless communication system including at least one wireless transmit/receive unit (WTRU) with a re-ordering release timer, and at least one Node-B with a buffer for storing data including at least one protocol data unit (PDU), the Node-B for scheduling urgent data comprising:
(a) a buffer for storing data including at least one protocol data unit (PDU);
(b) a transmitter; and
(c) a high speed downlink packet access (HSDPA) scheduler for determining whether there is at least one PDU in the buffer waiting to be transmitted by the transmitter, wherein the re-ordering release timer in the WTRU will expire if the PDU is not transmitted by the Node-B in a next N transmission timing interval (TTI), where N is a design parameter, and the HSDPA scheduler treats the PDU as urgent data if the re-ordering release timer is close to expiring.

86. The Node-B of claim 85 wherein the HSDPA scheduler will arrange a sequence of WTRUs scheduled to receive urgent data in an order of decreasing priority, and sequentially selects for scheduling urgent data associated with each of the WTRUs in accordance with the sequence.

87. The Node-B of claim 85 wherein the Node-B considers using a more conservative modulation and coding scheme (MCS) if the re-ordering release timer is close to expiring.

88. The Node-B of claim 85 wherein the Node-B considers using multiple code transmission if the re-ordering release timer is close to expiring.

89. The Node-B of claim 85 wherein the Node-B uses a redundancy reversion other than one used in a previous transmission if the re-ordering release timer is close to expiring.

90. The Node-B of claim 85 wherein the HSDPA scheduler schedules non-urgent data if there are no WTRUs in the sequence for which urgent data has not been scheduled.

91. In a wireless communication system including at least one wireless transmit/receive unit (WTRU) with a re-ordering release timer, and at least one Node-B with a buffer for storing data including at least one protocol data unit (PDU), an integrated circuit (IC) incorporated in the Node-B for scheduling urgent data, the IC comprising:
(a) a buffer for storing data including at least one protocol data unit (PDU);
(b) a transmitter; and
(c) a high speed downlink packet access (HSDPA) scheduler for determining whether there is at least one PDU in the buffer waiting to be transmitted by the transmitter, wherein the re-ordering release timer in the WTRU will expire if the PDU is not transmitted by the Node-B in a next N transmission timing interval (TTI), where N is a design parameter, and the HSDPA scheduler treats the PDU as urgent data if the re-ordering release timer is close to expiring.

92. The IC of claim 91 wherein the HSDPA scheduler arranges a sequence of WTRUs scheduled to receive urgent data in an order of decreasing priority, and sequentially selects for scheduling urgent data associated with each of the WTRUs in accordance with the sequence.

93. The IC of claim 91 wherein the Node-B considers using a more conservative modulation and coding scheme (MCS) if the re-ordering release timer is close to expiring.

94. The IC of claim 91 wherein the Node-B considers using multiple code transmission if the re-ordering release timer is close to expiring.

95. The IC of claim 91 wherein the Node-B uses a redundancy reversion other than one used in a previous transmission if the re-ordering release timer is close to expiring.

96. The IC of claim 91 wherein the HSDPA scheduler schedules non-urgent data if there are no WTRUs in the sequence for which urgent data has not been scheduled.
